(19) United States
(12) Patent Application Publication
(10) Pub. No.: US 2016/0353261 A1
(43) Pub. Date: Dec. 1, 2016

(54) DISTRIBUTED CALL ADMISSION CONTROL ON UNITY RADIO IN A CLUSTER DEPLOYMENT

(71) Applicant: Aruba Networks, Inc., Sunnyvale, CA (US)

(72) Inventors: Navaneetha Krishna Gowda Thippesh, Bangalore (IN); Brijesh Yadav, Bangalore (IN)

(73) Assignee: Aruba Networks, Inc., Sunnyvale, CA (US)

(21) Appl. No.: 14/721,944

(22) Filed: May 26, 2015

(51) Int. Cl. H04W 4/16; H04L 29/06

(52) U.S. Cl. CPC H04W 4/16; H04L 65/80; H04W 88/08

(57) ABSTRACT

Various techniques and systems are provided for executing call admission control in a cluster deployment including the sharing of call and capacity information between controllers in a cluster to make call capacity decisions for an access point. Implementations describe devices, computer-program products, and methods including a controller managing an access point retrieving access point capacity information from a storage library; receiving a call communication to initiate a call, wherein the call communication includes a request by a client device associated with the access point; determining a call capacity required by the call; determining that the access point has sufficient capacity for the call to be initiated, wherein determining includes using the access point capacity information and the call capacity required by the call; initiating the call; and updating the storage library with updated access point capacity information, wherein updating the storage library facilitates determining an updated capacity of the access point by another controller.

### FIELD

The present disclosure relates to a computer technology for distributed call admission control on unity radio in a cluster deployment. Specifically, various techniques and systems are provided for executing call admission control in a cluster deployment including the sharing of call and capacity information between controllers in a cluster to make call capacity decisions for an access point.

### BRIEF SUMMARY

The present disclosure relates to systems and methods including a computer technology for distributed call admission control on unity radio in a cluster deployment. Specifically, various techniques and systems are provided for executing call admission control in a cluster deployment including the sharing of call and capacity information between controllers in a cluster to make call capacity decisions for an access point.

In an embodiment, the present technology includes a computer-implemented method. The computer-implemented method may comprise, for example, retrieving, by a controller that manages an access point, access point capacity information from a storage library, wherein access point capacity information includes a number of calls or an amount of bandwidth that can be accommodated by the access point, receiving a request to initiate a call, wherein the request is made by a client device associated with the access point, determining a call capacity required by the call, determining that the access point has sufficient capacity for the call to be initiated, wherein determining includes using the access point capacity information and the call capacity required by the call, initiating the call, and updating the storage library with updated access point capacity information, wherein updating the storage library facilitates determining an updated capacity of the access point by another controller.

In an aspect, for example, updated access point capacity information is determined using the existing access point capacity information and information about the call. In an aspect, for example, determining a call capacity required by the call further includes transmitting a communication including a request for the call capacity required by the call, and receiving a response to the communication including the call capacity required by the call. In an aspect, for example, the method further comprises determining the type of call and determining that the access point has enough capacity for that type of call to be initiated using information about the type of call, the access point capacity, and the call capacity required by the call. In an aspect, for example, the access point capacity information includes a number of active calls on the access point, and determining that the access point has sufficient capacity for the call to be initiated includes comparing the number of active calls on the access point to a threshold number of calls. In an aspect, for example, the access point capacity information includes an amount of bandwidth available on the access point, and wherein determining that the access point has sufficient capacity for the call to be initiated includes comparing the call capacity required by the call to a threshold amount or percentage of bandwidth.

In an embodiment, the present technology includes a network device. The network device may comprise, for example, one or more processors and a non-transitory computer-readable medium. The computer-readable medium may contain instructions that, when executed by the one or more processors, cause the one or more processors to perform operations. The operations may include: retrieving, by a controller that manages an access point, access point capacity information from a storage library, receiving a call communication to initiate a call, wherein the call communication includes a request by a client device associated with the access point, determining a call capacity required by the call, determining that the access point has sufficient capacity for the call to be initiated, wherein determining includes using the access point capacity information and the call capacity required by the call, initiating the call, and updating the storage library with updated access point capacity information, wherein updating the storage library facilitates determining an updated capacity of the access point by another controller.

In an aspect, for example, updated access point capacity information is determined using the access point capacity information and initiation of the call. In another aspect, for example, determining a call capacity required by the call further includes: transmitting a communication including a request for the call capacity required by the call; and receiving a response to the communication including the call capacity required by the call. In another aspect, for example, the network device further comprises instructions that, when executed by the one or more processors, cause the one or more processors to perform operations including: determining a type of call associated with the call; and determining that the access point has enough capacity for the call to be initiated using the type of call, the access point capacity information, and the call capacity required by the call. In another aspect, for example, the another controller manages the access point. In another aspect, for example the access point capacity information includes a number of active calls on the access point, and wherein determining that the access point has sufficient capacity for the call to be initiated includes comparing the number of active calls on the access point to a threshold number of calls. In another aspect, for example, the access point capacity information includes an amount of bandwidth available on the access point, and wherein determining that the access point has sufficient capacity for the call to be initiated includes comparing the call capacity required by the call to a threshold amount or percentage of bandwidth. In another aspect, for example, access point capacity information includes a number of calls or an amount of bandwidth available on the access point.

In an embodiment, the present technology includes a computer-program product. The computer-program product may be tangibly embodied in a non-transitory machine-readable storage medium of a computing device. The non-transitory machine-readable storage medium may include instructions that, when executed by one or more processors, cause the one or more processors to retrieve, by a controller that manages an access point, access point capacity information from a storage library, receive a call communication to initiate a call, wherein the call communication includes a request by a client device associated with the access point, determine a call capacity required by the call, determine that the access point has sufficient capacity for the call to be initiated, wherein determining includes using the access point capacity information and the call capacity required by the call, initiate the call, and update the storage library with updated access point capacity information, wherein updating the storage library facilitates determining an updated capacity of the access point by another controller.

In an aspect, for example, updated access point capacity information is determined using the access point capacity information and initiation of the call. In another aspect, for example, determining a call capacity required by the call further includes: transmitting a communication including a request for the call capacity required by the call; and receiving a response to the communication including the call capacity required by the call. In another aspect, for example, the network device further comprises instructions that, when executed by the one or more processors, cause the one or more processors to perform operations including: determining a type of call associated with the call; and determining that the access point has enough capacity for the call to be initiated using the type of call, the access point capacity information, and the call capacity required by the call. In another aspect, for example, the another controller manages the access point. In another aspect, for example the access point capacity information includes a number of active calls on the access point, and wherein determining that the access point has sufficient capacity for the call to be initiated includes comparing the number of active calls on the access point to a threshold number of calls. In another aspect, for example, the access point capacity information includes an amount of bandwidth available on the access point, and wherein determining that the access point has sufficient capacity for the call to be initiated includes comparing the call capacity required by the call to a threshold amount or percentage of bandwidth. In another aspect, for example, access point capacity information includes a number of calls or an amount of bandwidth available on the access point.

The terms and expressions that have been employed are used as terms of description and not of limitation, and there is no intention in the use of such terms and expressions of excluding any equivalents of the features shown and described or portions thereof. It is recognized, however, that various modifications are possible within the scope of the systems and methods claimed. Thus, it should be understood that although the present system and methods have been specifically disclosed by embodiments and optional features, modification and variation of the concepts herein disclosed may be resorted to by those skilled in the art, and that such modifications and variations are considered to be within the scope of the systems and methods as defined by the appended claims.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments are described in detail below with reference to the following figures:

FIG. 1 illustrates one embodiment of a network configuration that may be implemented for systems and methods including a computer technology for distributed call admission control on unity radio in a cluster deployment, according to embodiments of the present technology.

FIG. 2 illustrates an embodiment of a network configuration that includes a cloud-based management service, according to embodiments of the present technology.

FIG. 3 illustrates another embodiment of a network configuration, according to embodiments of the present technology.

FIG. 4A illustrates another embodiment of a network configuration including a router, two controllers, an access point, and clients associated with the access points, according to embodiments of the present technology.

FIG. 4B illustrates another embodiment of a network configuration including a router, two controllers, an access point, and clients associated with the access points, according to embodiments of the present technology.

FIG. 5A illustrates another embodiment of a network configuration including a router, two controllers, an access point, and clients associated with the access point, according to embodiments of the present technology.

FIG. 5B illustrates another embodiment of a network configuration including a router, five controllers, an access point, and clients associated with the access point, according to embodiments of the present technology.

FIG. 6 illustrates another embodiment of a network configuration including a router, two controllers, an access point, and clients associated with the access points, according to embodiments of the present technology.

FIG. 7A illustrates a simplified embodiment of a network configuration including four controllers C1, C2, C3 and C4, an access point, and clients D1, D2, D3 and D4 associated with the access points, according to embodiments of the present technology.

FIG. 7B illustrates a block diagram showing a cluster of four controllers C1, C2, C3 and C4 and clients D1, D2, D3 and D4, according to embodiments of the present technology.

FIG. 8A illustrates a block diagram showing a stage of a progression of added and dropped calls and related call admission control in an example cluster deployment, according to embodiments of the present technology.

FIG. 8B illustrates a block diagram showing a stage of a progression of added and dropped calls and related call admission control in an example cluster deployment, according to embodiments of the present technology.

FIG. 8C illustrates a block diagram showing a stage of a progression of added and dropped calls and related call admission control in an example cluster deployment, according to embodiments of the present technology.

FIG. 8D illustrates a block diagram showing a stage of a progression of added and dropped calls and related call admission control in an example cluster deployment, according to embodiments of the present technology.

FIG. 9 is a flow chart showing an example process for call admission control for a cluster of controllers, according to embodiments of the present technology.

FIG. 10 illustrates an embodiment of a special-purpose computer system, according to embodiments of the present technology.

### DETAILED DESCRIPTION

In the following description, for the purposes of explanation, specific details are set forth in order to provide a thorough understanding of embodiments of the technology. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the technology as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable medium may include a non-transitory medium in which data can be stored. Examples of a non-transitory medium may include, but are not limited to, a magnetic disk or tape, optical storage media such as compact disk (CD) or digital versatile disk (DVD), flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. A processor(s) may perform the necessary tasks.

Systems depicted in some of the figures may be provided in various configurations. In some embodiments, the systems may be configured as a distributed system where one or more components of the system are distributed across one or more networks in a cloud computing system.

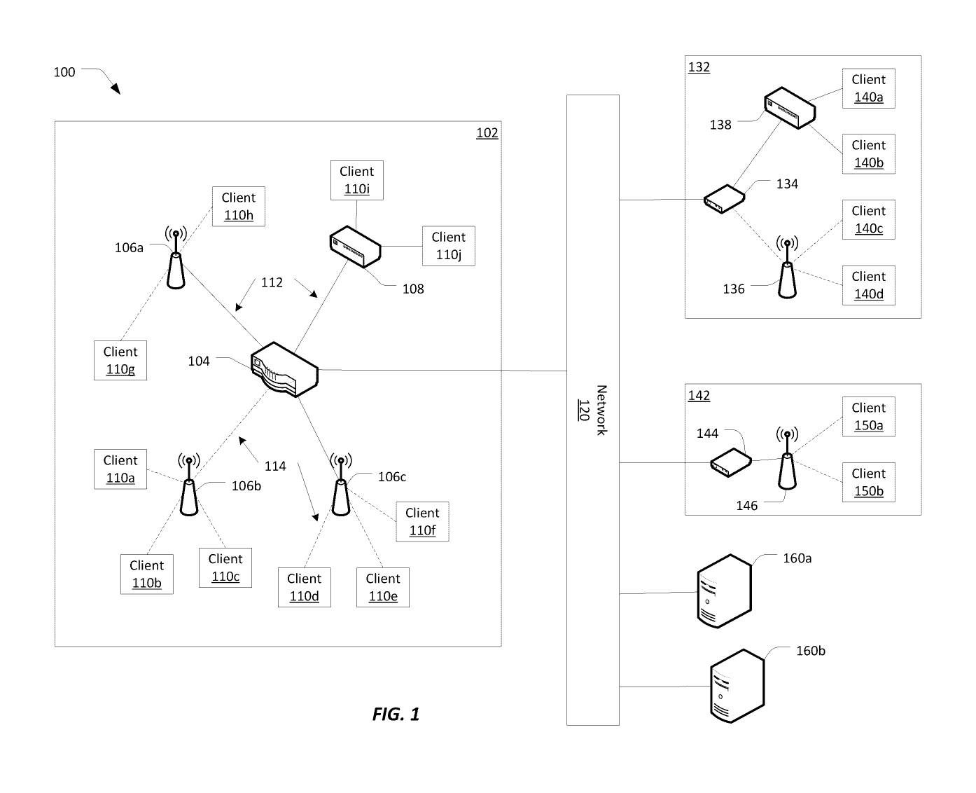

FIG. 1 illustrates one embodiment of a network configuration 100 that may be implemented for a multi-user organization, such as a business, educational institution, governmental entity, or any other organization having multiple users and possibly multiple physical or geographical sites. The network configuration 100 may include a main office 102 in communication with a network 120. The network configuration 100 may also include one or more remote sites 132, 142, also in communication with the network 120.

The main office 102 may include a primary network, possibly also called a corporate network or a home network. The main office 102 network may be a private network. A private network is a network that may include security and access controls, such that only certain users are authorized to access the private network. Authorized users may include, for example, employees of a company based in the main office 102.

In the illustrated embodiment, the main office 102 includes a controller 104 in communication with the network 120. The controller 104 may provide communication with the network 120 for the main office 102, though it may not be the only point of communication with the network 120 for the main office 102. A single controller 104 is illustrated, though the main office may include multiple controllers and/or multiple communication points with network 120. In some embodiments, the controller 104 communicates with the network 120 through a router (not illustrated). In other embodiments, the controller 104 provides router functionality to the devices in the main office 102.

A controller 104 is operable to configure and manage network devices, such as the main office 102, and may also manage network devices at the remote sites 132, 134. The controller 104 may be operable to configure and/or manage switches, routers, access points, and/or client devices connected to a network. The controller 104 may itself be, or provide the functionality of, an access point.

The controller 104 may be in communication with one or more switches 108 and/or wireless access points 106a-c. Switches 108 and wireless access points 106a-c provide network connectivity to various client devices 110a-j. Using a connection to a switch 108 or access point 106a-c, a client device 110a-j is able to access network resources, including other devices on the network and the network 120.

Examples of client devices include, but are not limited to: desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, netbook computers, televisions and similar monitors, content receivers, set-top boxes, personal digital assistants (PDAs), mobile phones, smart phones, smart terminals, dumb terminals, virtual terminals, video game consoles, and the like.

Within the main office 102, a switch 108 is included as one example of a point of access to the network for wired client devices 110i-j. Client devices 110i-j may connect to the switch 108 and through the switch 108 may be able to access other devices within the network configuration 110. The client devices 110i-j may also be able to access the network 120, through the switch 108. The client devices 110i-j may communicate with the switch 108 over a wired 112 connection. In the illustrated example, the switch 108 communicates with the controller 104 over a wired 112 connection, though this connection may also be wireless.

Wireless access points 106a-c are included as another example of a point of access to the network for client devices 110a-h. An access point 106a-c is a combination of hardware, software, and/or firmware that is configured to provide wireless network connectivity to wireless client devices 110a-h. In the illustrated embodiment, the access points 106a-c can be managed and configured by the controller 104. The access points 106a-c communicate with the controller 104 and the network over either wired 112 or wireless 114 connections.

Client devices within a network (e.g. wireless local area networks, or “WLANs”) communicate with access points in order to obtain access to one or more network resources. An access point, referred to as an “AP”, may include a digital device that operates as a gateway for a client device to establish a connection (e.g., a communicative coupling) with one or more networks (e.g., the Internet, an intranet, etc.). For example, an access point may be implemented as a wireless access point (WAP), which is configured to communicate wirelessly with one or more client devices as well as communicate with a networked device associated with the one or more networks, such as a controller for example, through a wired connection.

The network configuration 100 may include one or more remote sites 132, 142. A remote site 132 may be located in a different physical or geographical location from the main office 102. In some cases the remote site 132 may be in the same geographical location, or possibly the same building, as the main office, 102, but lacks a direct connection to the network located within the main office 102, relying instead on a connection over a different network 120. A remote site 132 such as the one illustrated may be, for example, a satellite office. The remote site 132 may include a gateway device 134 for communicating with the network 120. A gateway device 134 may be a router, a digital-to-analog modem, a cable modem, a Digital Subscriber Line (DSL) modem, or some other network device configured to communicate to the network 120. The remote site 132 may also include a switch 138 and/or access point 136 in communication with the gateway 134 over either wired or wireless connections. The switch 138 and access point 136 provide connectivity to the network for various client devices 140a-d.

In various embodiments, the remote site 132 is in direct communication with main office 102, such that client devices 140a-d at the remote site 132 access the network resources at the main office 102 as if these clients 140a-d were located at the main office 102. In such embodiments, the remote site 132 is managed by the controller 104 at the main office, and the controller 104 provides the necessary connectivity, security, and accessibility that enable the remote site's 132 communication with the main office 102. Once connect to the main office 102, the remote site 132 may function as a part of a private network provided by the main office 102.

In various embodiments, the network configuration 100 may include one or more smaller remote sites 142, comprising only a gateway device 144 for communicating with the network 120 and a wireless access point 146, by which various client devices 150a-b access the network 120. Such a remote site 142 may represent, for example, an individual employee's home or a temporary remote office. The remote site 142 may also be in communication with the main office 102, such that the client devices 150a-b at remote site 142 access network resources at the main office 102 as if these client devices 150a-b were located at the main office 102. The remote site 142 may be managed by the controller 104 at the main office 102 to make this transparency possible. Once connected to the main office 102, the remote site 142 may function as a part of a private network provided by the main office 102.

The network 120 may be a public network, such as the Internet. A public network is a network that may be shared by any number of entities, including the illustrated network configuration 100. A public network may have unrestricted access, such that any user may connect to it. The network 120 may include any number of intermediate network devices, such as switches, routers, gateways, servers, and/or controllers, that are not directly part of the network configuration 100 but that facilitate communication between the various parts of the network configuration 100, and between the network configuration 100 and other network-connected entities. The network 120 may include various content servers 160a-b. Content servers 160a-b may include various providers of multimedia downloadable and/or streaming content, including audio, video, graphical, and/or text content, or any combination thereof. Examples of content servers 160a-b include, for example, web servers, streaming radio and video providers, and cable and satellite television providers. The client devices 110a-j, 140a-d, 150a-b may request and access the multimedia content provided by the content servers 160a-b.

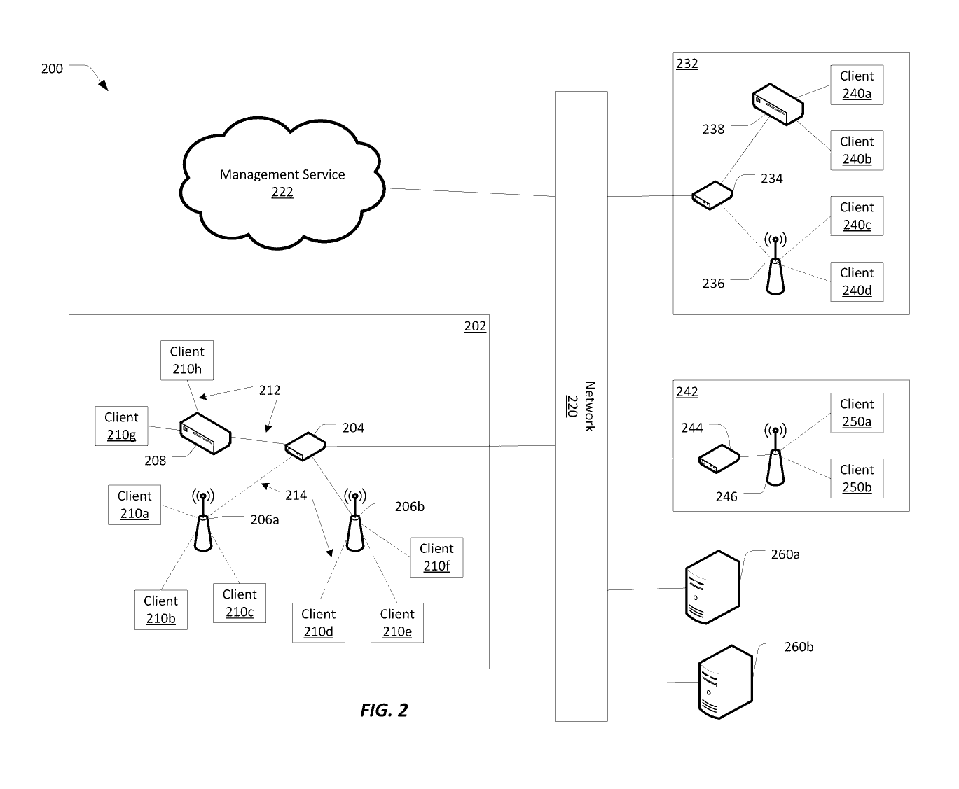

FIG. 2 illustrates an embodiment of a network configuration 200 that includes a cloud-based management service 222. The network configuration 200 may be implemented for a multi-user organization. The network configuration 200 includes a main office 202 in communication with a network 220, and may also include one or more remote sites 232, 242, also in communication with the network 220. In the illustrated embodiment, the main office 202 includes a gateway device 204, such as a router, for communicating with the network 220. A single gateway device 204 is illustrated, though the main office 202 may include multiple gateway devices and/or multiple communication points with the network 220.

The gateway device 204 may be in communication with one or more switches 208 and/or wireless access points 206a-b. Routers 208 and access points 206a-b provide network connectivity to various client devices 210a-h. Using a connection to a switch 208 or access point 206a-b, a client device 210a-h is able to access network resources, including other devices on the network and the network 220.

A switch 208 is included as an example of a point of access to the network for client devices 210g-h. Client devices 210g-h may communicate with the switch 208 over a wired 212 connection. Wireless access points 206a-b are included as another example of a point of access to the network for client devices 210a-f. Client devices 210a-f may communicate with the access points 206a-b over wireless 214 connections. The access points 206a-b may themselves communicate with the gateway device 204 over either wired 212 or wireless 214 connections.

In some embodiments, the network configuration 200 may include a cloud-based management service 222. The management service 222 may include various software and software processes for configuring and/or managing network devices at the main office 202. Management tasks may include, for example, access, authentication, security, hardware management, and/or internal and/or external communication. The management service 222 may be running on a server local to the main office 202, or a server located remotely from the main office 202, or may be distributed across any number of local and/or remote servers. In embodiments where the management service 222 is located remote to the main office 202, the management service 222 may access the main office 202 over the network 220.

The network configuration 200 may include one or more remote sites 232, 242. A remote site 232 may include a gateway device 234 for communicating with the network 220. The remote site 232 may also include a switch 238 and/or access point 236 in communication with the gateway device 234 over either wired or wireless connections. The switch 238 and access point 236 provide connectivity to the network 220 for various client devices 240a-d.

In various embodiments, the remote site 232 may be configured and/or managed by the management service 222, such that client devices 240a-d at the remote site 232 access the network resources at the main office 202 as if these clients 240a-d were located at the main office 202. The management service 222 provides the necessary connectivity, security, and accessibility that enable the remote site's 232 communication with the main office 202.

In various embodiments, the network configuration 200 may also include one or more smaller remote sites 242, comprising only a gateway device 244 for communicating with the network 220 and a wireless access point 246, by which various client devices 250a-b access the network 220. The remote site 242 may also be configured and/or managed by the management service 222, such that the client devices 250a-b at the remote site 242 access network resources at the main office 202 as if these client devices 250a-b were located at the main office 202. The management service's 222 control over the remote site 242 makes this transparency possible.

The network 120 may be a public network, such as the Internet. The network 120 may include various content servers 260a-b. The client devices 210a-h, 240a-d, 250a-b may request and access data and content provided by the content servers 260a-b over their connection to the network 120.

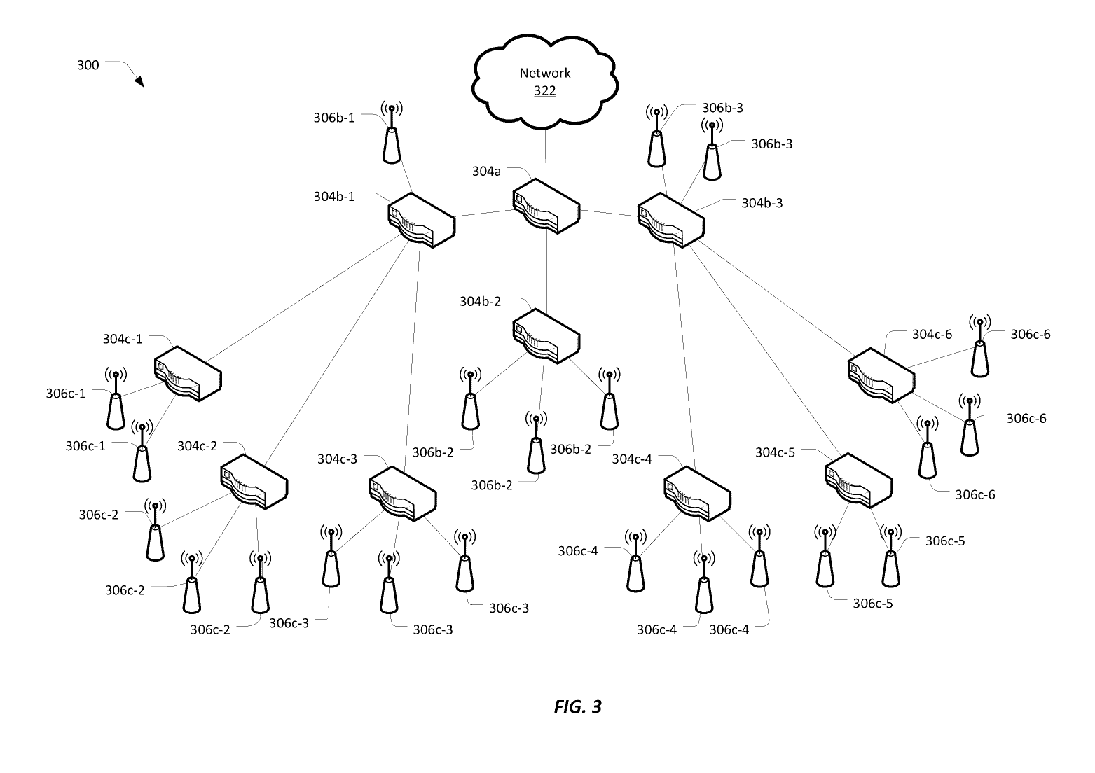

FIG. 3 illustrates another embodiment of a network configuration 300, according to embodiments of the present technology. Specifically, illustrated in FIG. 3 is an example of a controller cluster configuration 300. A controller cluster configuration 300 includes a number of controllers 304a-c in communication with one another. The various controllers 304a-c may be located in the same location, such as for example in a main office. Alternatively or additionally, some of the controllers may be located at remote sites, and communicate with the other controllers over a combination of networks that may include the Internet.

A cluster of controllers may comprise a network entity serving (which may include configuring or managing) one or more access points and/or one or more wireless clients. All of the controllers within a cluster may include the same functionalities and capabilities so that any individual controller may serve any individual access point and any individual client device at any time. Alternatively, some of the controllers in the cluster may be configured to serve access points and some configured to serve client devices. This allows for the balancing of the workload among all of the controllers in any preferred distribution scheme. For example, in one embodiment, the workload may be balanced as evenly as possible among the controllers. Furthermore, more client devices may be served when multiple controllers communicate than when a single controller handles all access points and all client devices on a network.

Controller clusters have various benefits. For example, when one controller handles all access points and all client devices on a network, there may be a large fault domain. When a controller that handles all or a large percentage of the access points or clients on the network fails or is unavailable, the impact may be highly detrimental to the network. By distributing the workload of one or more access points or one or more client devices across a cluster of controllers having the same functionalities and capabilities, there is less of an impact when a controller fails or is unavailable to handle access points or client devices.

Referring specifically to FIG. 3, a controller 304a may be configured to be primary controller 304a. The primary controller 304a may also be called the cluster root controller, the master controller, or the user anchor controller (UAC). The primary controller 304a may be responsible for configuring and/or managing the controller cluster. In some embodiments, the primary controller 304a may be connected to a router, switch, and/or gateway (not illustrated), to connect to a network 322 outside of the cluster.

The controller cluster may include a number of secondary controllers 304b. The secondary controllers 304b each communicate with the primary controller 304a. The secondary controllers 304b are typically “downstream” from the primary controller 304a; that is, the secondary controllers 304b may be closer to any client devices that are part of the cluster configuration 300 (the “downstream” direction), and further away from the connection to the network 322 (the “upstream” direction). In some embodiments, one or more of the secondary controllers 304b may be connected to one or more access points 306b. For example, the controller 304b-2 may be connected to three access points 306b-2. A controller—including any controller “upstream” or “downstream” from a secondary controller 304b—that is connected to one or more access points may be referred to as an access point anchor controller (AAP). A secondary controller 304b may provide configuration and/or management services for any access points 306b—that are connected to it. The secondary controller 304b may further or instead provide configuration and/or management serves for any client devices (not shown) associated with an access point 306b. In some embodiments, a secondary controller 304b may also function as a UAC.

In some embodiments, the controller cluster may also include a number of tertiary controllers 304c. Each tertiary controllers 304c may be connected to one secondary controller 304b in the “upstream” direction. In some embodiments, a tertiary controller 304c may not be connected to any controllers in the “downstream” direction. Such a controller may be referred to as a local controller. Tertiary controllers 304c may be connected to any number of access points 306c. The tertiary controller 304c may provide configuration and/or management services for any of the access points 306c that are connected to it. The tertiary controller 304c may also or instead provide configuration and/or management services for any client devices (not shown) associated with an access point 306.

The example of FIG. 3 illustrates a controller cluster configuration 300 consisting of three (primary, secondary, and tertiary) levels to provide an example of a cluster configuration 300. A controller cluster configuration 300 may include more or fewer levels, as is desirable and/or practicable for a given situation. Furthermore, the number of controllers within a cluster or within a level of a cluster is not static. The number of controllers may increase or decrease for numerous reasons. Examples of such reasons may include, but are not limited or restricted to, the addition of a new controller to the system, the failure or the purposeful deactivation of a controller (e.g., to perform a software upgrade on the controller).

Controllers at different levels of the cluster configuration 300 may provide similar or different services for the devices connected to them. For example, a controller may provide configuration and/or management services to only devices at the next downstream level. For example, the controller 304a may configure and manage only the controllers 304b-1, 304b-2, and 304b-3. Further, the controller 304b-1 may configure and manage only the controllers 304c-1, 304c-2, and 304c-3 connected to it, in addition to the access point 306b-1, also connected to it. Alternatively or additionally, a controller may provide configuration and/or management services for all devices in the downstream direction. It may be more advantageous and practical, however, to distribute the configuration and management duties among the various controllers.

As noted, a controller may provide configuration and management access points and/or network devices on the network. For example, a controller may help or facilitate an access point's initial connecting, or reconnecting, to the network (e.g. to the controller, or becoming associated with a client device on the network). More specifically, a controller may provide information related to an access point's entrance to the network, including a network SSID or password, client devices on the network for the access point to be associated with, among other information. A controller may also help manage an access point or other device on the network, for example by providing information related to which traffic passing through the controller or through the access point should have priority over other information. A controller may also provide services other than configuration and/or management. For example, a controller may also terminate or firewall client or other user data traffic on the controller, on access points connected to the controller, or other services.

Call Admission Control (CAC) is a concept that prevents oversubscription of data traffic on a network such as, for example, a voice over IP (VoIP) network. For example, if an influx of traffic enters such a network, Call Admission Control may help one or more devices on the network make decisions (e.g. queueing, buffering, packet drop, etc.) to resolve the problem. More specifically, Call Admission Control can help an access point on a network determine whether a new call that a client device (e.g. a client device that is associated with the access point) is attempting to initiate should or can be initiated based on the calls and other network traffic that are already taking place on the network and at that access point.

In many networks, each access point (and other network devices) on a network may be managed by a single controller on the network. Therefore, a single controller may manage all of the traffic that flows through the access point, such as requests to initiate new calls by client devices associated with that access point. When a client device associated with the access point attempts to initiate a call, the controller has the information it needs to make a decision about whether to allow the call to be initiated. More specifically, since the controller is the only controller that manages the access point, the controller knows how many client devices are currently associated with the access point, how many calls are taking place at any given time via the access point, how much bandwidth the access point has for new calls, when there is increased availability for new calls because, for example, calls drop off the access point, and other data about the access point and the clients associated with it.

However, in a controller cluster environment, such as the environment shown in FIG. 3, multiple controllers may manage a single access point. Different client devices associated with a single access point may terminate on different controllers. Therefore, a single controller may not have access to all of the information it needs to make a decision about whether to allow a new call to be initiated. For example, while a first controller may receive a request from a first client device to initiate a new call via the access point, a different controller (e.g. different than the first controller) may also receive a request from a different client device (e.g. different than the first client device) to initiate another call. Since the two calls being initiated are coming from two different client devices, their respective controllers may not know that the other controller is also receiving a call initiation request.

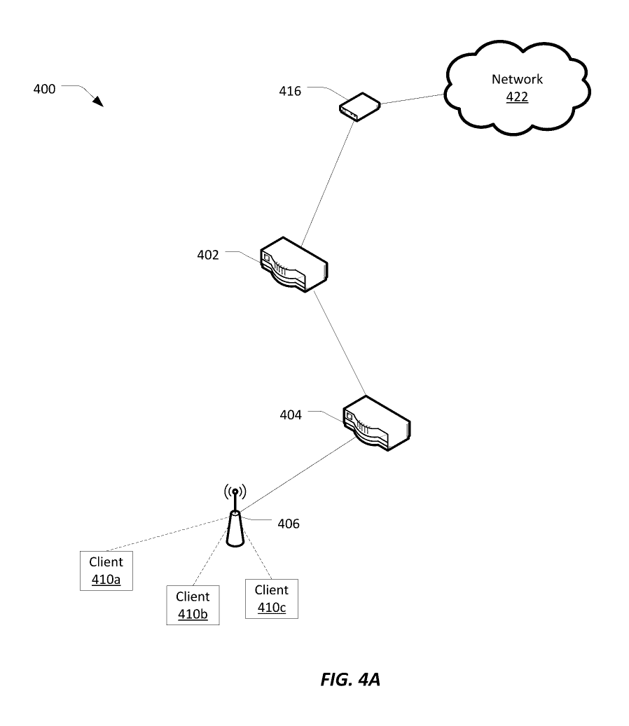

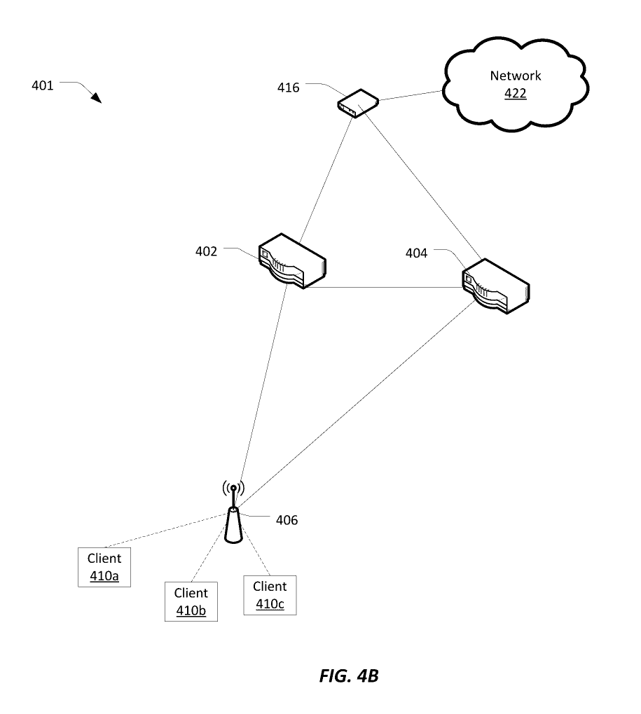

FIG. 4A illustrates another embodiment of a network configuration 400 including a router 416, two controllers 402 and 404, an access point 406, and clients associated with the access points, according to embodiments of the present technology. Network configuration 400 is similar to network configuration 300 in that network configuration 400 may be a small example portion of network configuration 300. As shown in FIG. 4A, controller 404 is downstream from controller 402. Therefore, access point 406 is connected to controller 404. However, controller 402 may still manage access point 406 because, in certain embodiments, a controller may manage any devices downstream from it. Clients 410a, 410b and 410c are each connected to the network via access point 406.

In an embodiment, controller 402 may configure and manage only the controller 404. Further, controller 404 may configure and manage only access point 406 connected to it. Alternatively or additionally, a controller may provide configuration and/or management services for all devices in the downstream direction. For example, controller 402 may provide configuration and/or management of controller 404, access point 406, and even clients 410a-c that are associated with access point 406. It may be more advantageous and practical, however, to distribute the configuration and management duties among the various controllers.

FIG. 4B illustrates another embodiment of a network configuration 401 including a router 416, two controllers 402 and 404, an access point 406, and clients associated with the access points, according to embodiments of the present technology. Network configuration 401 is similar to network configuration 300 except that controllers 402 and 404 are on the same controller level as each other, and each controller is associated with access point 406. Clients 410a, 410b and 410c are each connected to the network via access point 406. Other configurations other than those illustrated in FIGS. 4A and 4B are possible. The following described embodiments may be executed on either network configuration 400 or 401.

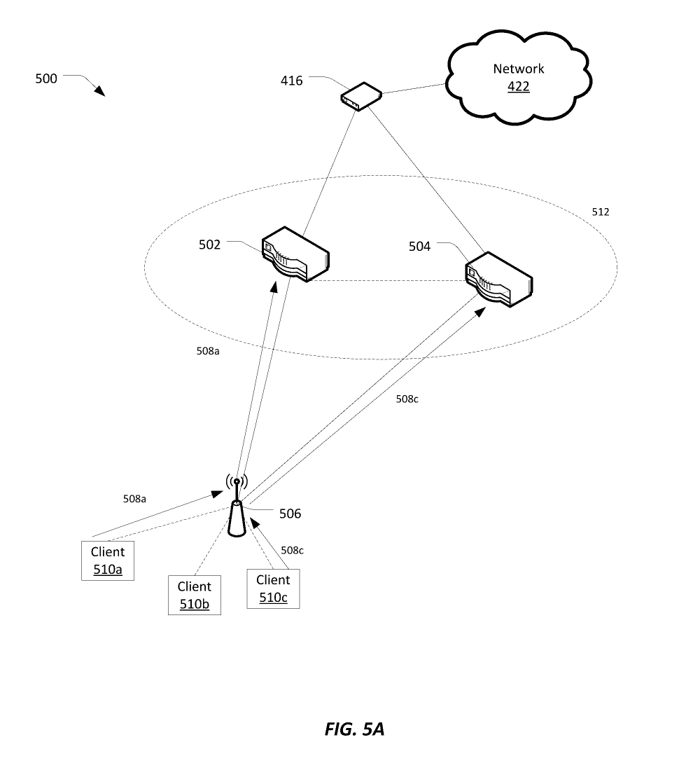

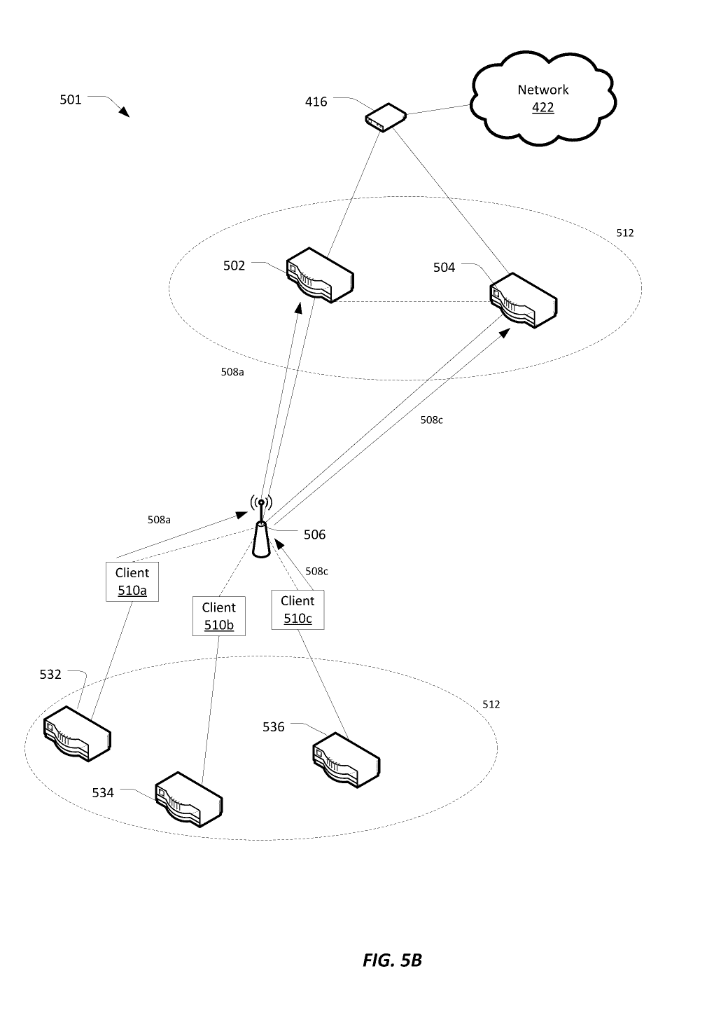

FIG. 5A illustrates another embodiment of a network configuration 500 including a router 416, two controllers 502 and 504, an access point 506, and clients associated with the access points, according to embodiments of the present technology. Network configuration 500 is similar to network configuration 401. Controllers 502 and 504 may be in a cluster configuration as indicated by cluster 512, such as that described herein with respect to FIG. 3. Clients 510a, 510b and 510c are each connected to the network via access point 506.

Client 510a may, for example, attempt to initiate a call via access point 506. For example, client 510a may attempt to initiate a call by transmitting a communication to access point 506 via communication path 508a. Since two controllers, controllers 502 and 504, manage access point 506, either controller 502 or controller 504 may manage the attempt to initiate a call by client 510a. In other words, client 510a may terminate at controller 502 or at controller 504, but, in an embodiment, terminates at only one but not both controllers. As shown in FIG. 5A, client 510a may attempt to initiate a call by transmitting a communication to access point 506 via communication path 508a. Client 510a terminates at controller 502 such that the request to initiate a call would end at controller 502. Therefore, information corresponding to the request or attempt to initiate a call by client 510a would be received at, or determined by, controller 502. Similarly, client 510c may attempt to initiate a call by transmitting a communication to access point 506 via communication path 508c. As shown in FIG. 5A, client 510c may attempt to initiate a call by transmitting a communication to access point 506 via communication path 508c, and client 510c terminates at controller 504 such that the request to initiate a call would end at controller 504. Therefore, information corresponding to the request or attempt to initiate a call by client 510c would be received at, or determined by, controller 504.

If clients 510a and 510c attempt to initiate a call at the same time or at close to the same time, controllers 502 and 504 may not know about the attempt to initiate a call received at, or determined by, the other controller. More specifically, controller 502 may only know that client 510a is attempting to initiate a call (because client 510a terminates at controller 502), and controller 502 may not know that client 510c is also attempting to initiate a call. Similarly, controller 504 may only know that client 510c is attempting to initiate a call (because client 510c terminates at controller 504), and controller 504 may not know that client 510a is also attempting to initiate a call. Therefore, since one or both controllers may not have all of the information available regarding the calls being initiated via access point 506 and/or information regarding the capacity of the access point, the controller(s) may not be able to make a fully educated or accurate decision regarding the access point's capacity for the calls. For example, if access point 506 has a call capacity (in this example, a number of calls, but it might also be, in another embodiment, a maximum bandwidth available or a capacity for the type of call requested) of five calls, and four other calls are active and taking place at the time clients 510a and 510c request to initiate calls, their respective end controllers 502 and 504 may only see that four calls are pending and may not see that the other controller also has a request for a new call. Therefore, both controllers may allow the calls to be initiated, causing more than the maximum of five calls to be allowed on the access point. Allowing more calls on the access point than the maximum allowed may cause one or more calls to be rejected by the access point, may cause one or more calls that are active to have errors due to not having enough availability through the access point, or other problems. This may happen similarly if the call capacity is limited by available bandwidth at the access point rather than number of calls. Available bandwidth may be determined not only by reference to calls pending at the access point but also by reference to client devices associated with the access point that are obtaining or seeking other types of services such as data retrieval, video streaming or multicast services.

When a controller receives a request or attempt to initiate a call by a client device, the controller may obtain information related to the type of call being initiated including the call's type (e.g. voice, video, etc.) and information to determine how much capacity the call may need on the access point. The controller may obtain such information in several ways. For example, the client device may, without prompting, send such information to the controller. In another example, the controller may already have such information based on past history of the device or type of device. In another example, the controller may request such information from the client device by transmitting a query to the client device and receiving an answer to the query back from the client device.

Although the embodiment described with respect to FIG. 5A (and also described with respect to other figures herein) includes two controllers, more or fewer controllers may be included in similar embodiments. Furthermore, although the embodiment may be described with respect to, for example, two controllers AP anchor controllers (AACs), it may also be implemented with user anchor controllers (UACs) connected to client devices that are in the same cluster as AACs. For example, a single controller may act as both an AAC and UAC. In an alternative embodiment, a network may include AACs (e.g. controllers 502 and 504) and separate UAC controllers connected to network devices that help configure and/or manage the network devices they are connected to.

Such a configuration is illustrated in FIG. 5B. FIG. 5B illustrates another embodiment of a network configuration 501 including a router 416, two UAC controllers 502 and 504, three AAC controllers 532, 534 and 536, an access point 506, and clients associated with the access points, according to embodiments of the present technology. Network configuration 501 is similar to network configuration 500. Controllers 502, 504, 532, 534 and 536 may be in a cluster configuration as indicated by cluster 512, such as that described herein with respect to FIG. 3. Clients 510a, 510b and 510c are each connected to the network via access point 506.

Controllers 502 and 504 may, in configuration 501, serve to configure and/or manage access point 506 (and any other access points connected to it). This is because, unlike in configuration 500, controllers 502 and 504 in configuration 501 are AACs and not UACs. Controllers 532, 534 and 536 may, in configuration 501, serve to configure and/or manage clients 510a, 510b, and 510c (and any other client devices connected to it). This is because controllers 532, 534 and 536 are UACs. However, as noted, controllers 502, 504, 532, 534 and 536 may still be in the same cluster. Although FIG. 5B illustrates three UACs, embodiments of the present technology may include fewer or more controllers. For example, one controller (e.g. controller 532, 534 or 536) may serve more than one client device (e.g. client device 510a and client device 510b, or any other combination of client devices).

FIG. 6 illustrates another embodiment of a network configuration 600 including a router 616, two controllers 602 and 604, an access point 606, and clients associated with the access points, according to embodiments of the present technology. Network configuration 600 is similar to network configuration 500 in FIG. 5A. Controllers 602 and 604 may be in a cluster configuration as indicated by cluster 612, such as that described herein with respect to FIG. 3. Clients 610a, 610b and 610c are each connected to the network via access point 606.

Clients 610a, 610b or 610c may, over time, initiate many different calls via access point 606. Furthermore, pending calls previously initiated by clients 610a, 610b or 610c via access point 606 may be dropped or ended such that they leave the network or continue in the network in a different communication mode and cease or reduce their bandwidth usage on access point 606. Such calls may be managed or controlled by controllers 602 and 604 in cluster configuration 612. Since management of access point 606 may be shared by multiple controllers, controllers 602 and 604 may aggregate and share call (and access point capacity) information, and therefore access point capacity information, with each other as time goes on. For example, the call and capacity information may be stored in global share memory (GSM) 614. Global share memory 614 may be a virtualized centralized storage medium that allows for any controller in cluster 612 to share the information stored within it. However, global share memory 614 may be any other type of storage solution that allows two controller devices, which may be remote from one another, to share saved information. Whenever controller 602 or controller 604 receives a request to initiate a call from a client device, the controller may retrieve current (at the time the call request is received) capacity information from global share memory 614 to use when determining whether access point 606 has enough available capacity to accept another call.

The capacity of the network may be determined using a variety of methods, including the number of calls taking place on the network via the access point (i.e. call count), or the available bandwidth (e.g. in MB or GB) on the access point. The available bandwidth may be determined by comparing the required capacity of the new call as compared to an available amount of capacity on the access point, or by a percentage of bandwidth taken up on the access point. Available bandwidth may be determined not only by reference to calls pending at the access point but also by reference to client devices associated with the access point that are obtaining or seeking other types of services such as data retrieval, video streaming or multicast services.

Call or capacity information may also be shared between controllers in other ways, which may be used as the primary method of sharing information or as a backup method if a virtualized solution such as global share memory 614 is unavailable. For example, controllers 612 and 604 may share information by transmitting and receiving such information to each other any time a new call is initiated or dropped, or any time the access point capacity information has been updated. For example, either controller 602 or controller 604 or both may transmit such information via communication paths 618.

Global share memory 614 may be updated using various methods. In one embodiment, a controller (or other network device) may update global share memory 614 on a real time or automatic basis. In other words, a controller may update global share memory 614 by writing to storage every time controller 602 receives or generates new information regarding a new or dropped call or regarding the capacity of the access point 606. Simultaneously or substantially simultaneously to new information being stored in global share memory 614, the other controllers in the cluster may be able to access that information in their version or appearance of global share memory 614. In another embodiment, a controller may update global share memory 614 periodically (either regular or non-regular). Another controller in the cluster may retrieve information from global share memory 614 when it needs it. A controller may also receive update communications (either periodic, or in real time, or otherwise) from global share memory 614 any time an update is made to the information stored in global share memory 614. A benefit of using real-time or automatic updates is that the information will be obtainable by the cluster controllers soon after the updates are implemented. However, such real-time updating may require significant network bandwidth. A benefit of using non-real time updating is that this bandwidth requirement is lessened. However, updates may be delayed and controllers may not have all of the information available that is necessary to make an accurate call admission decision. Updating may take place in the form of syncing using a relevant syncing protocol. In any respect, a shared memory such as global share memory 614 offers the controllers a unified view of the call admission control situation for the relevant access point and any ongoing call requests or reservations made that might affect the call admission control situation.

As noted, call and capacity information may be stored in global shared memory 614. Each controller may have its own global shared memory. Any object stored in the global shared memory of each controller may be shared across all controllers in the same cluster. More specifically, each controller may listen to all channels shared between the different cluster controllers. Whenever a controller notices or receives a notification of an update on any channel, it may subscribe to that controller or to the controller's global shared memory so that it may pull or receive the update so it can update its global shared memory. A controller may only subscribe to certain channels or controllers so that it may select which controllers it receives updates from (because, for example, a controller may update its stored information on a specific channel). For example, a channel may be only used for voice or video data, and a controller may subscribe to that channel if it wants updates regarding changes in voice or video data from the other controllers. Other different channels may have different specific uses within the cluster.

The system may also use one or more of many mechanisms to sync the information stored between each controller in the cluster. For example, a data distribution service (e.g. multicast) may be used to distribute information between the controllers. In one embodiment, the service or system may create channels between the cluster member controllers. When an update to the storage mechanism is updated, the channels may be used to automatically sync storage within each controller. Such channels may be used to transmit other information other than such updates (e.g. call admission control updates).

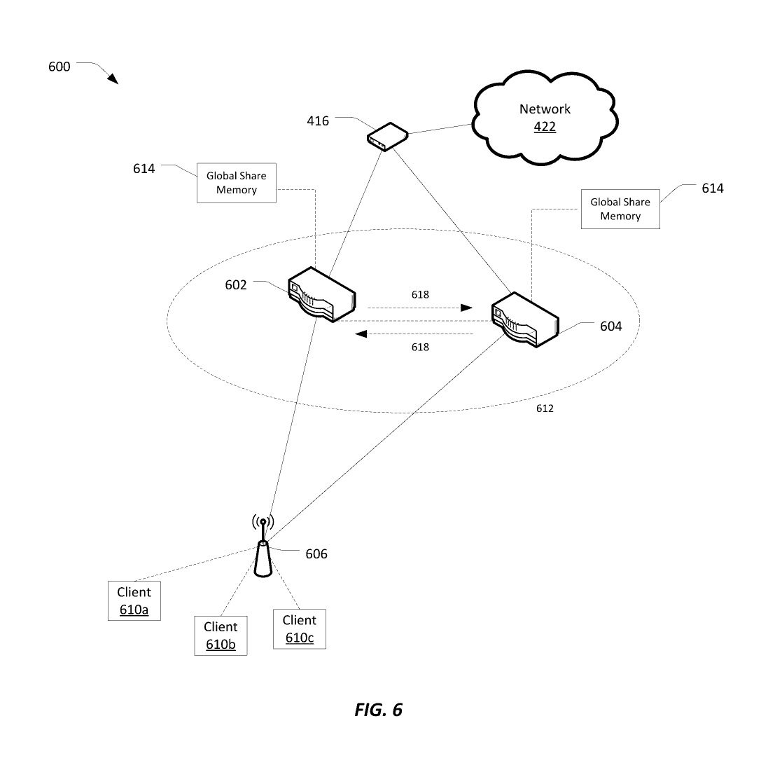

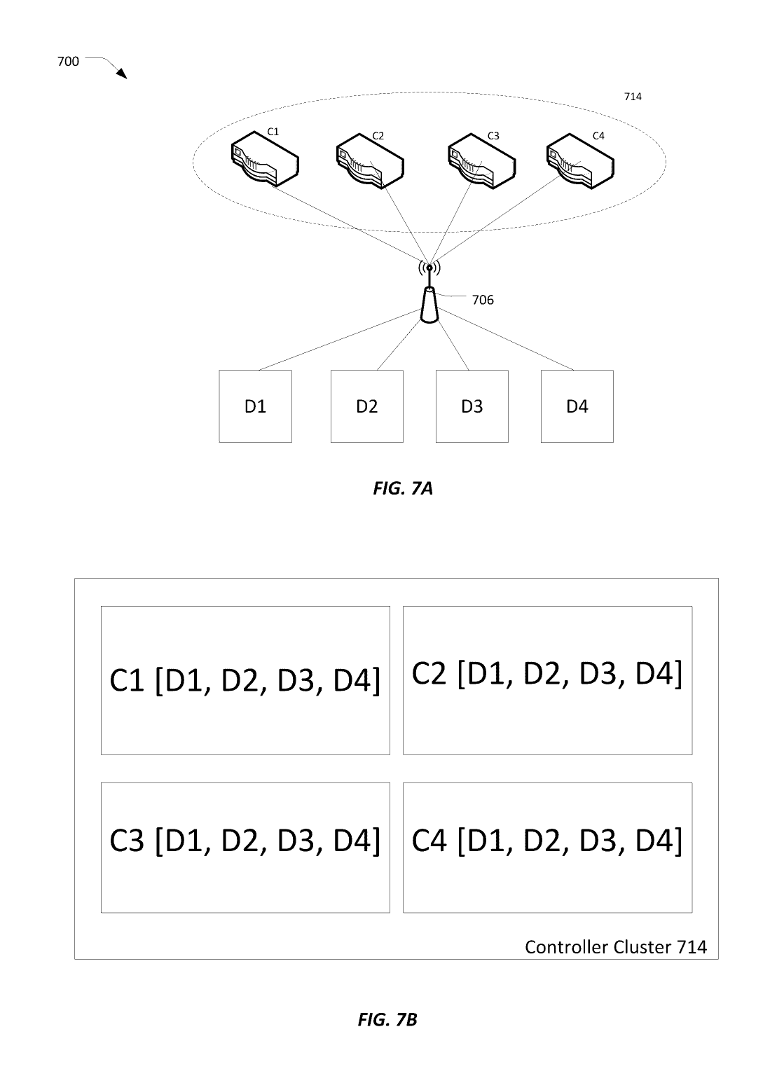

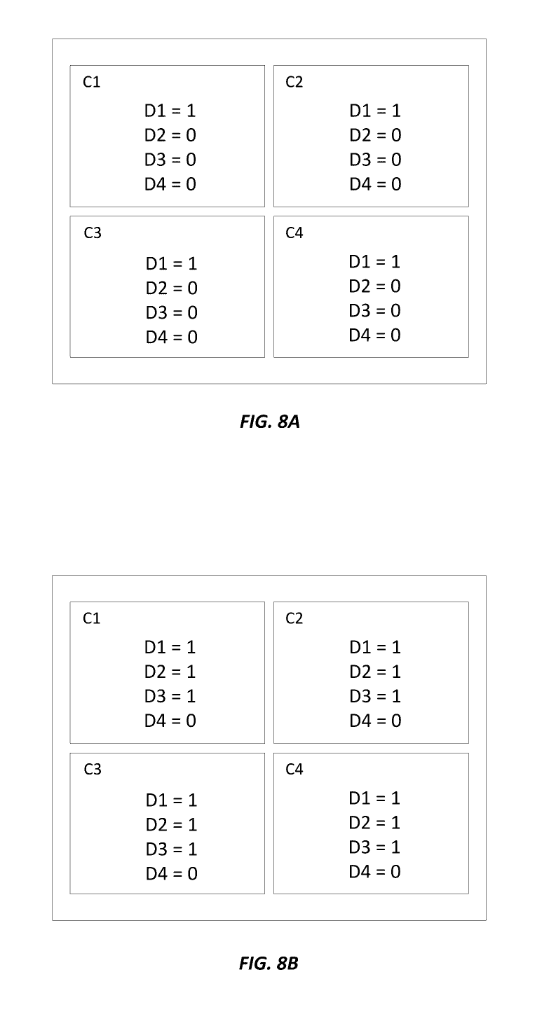

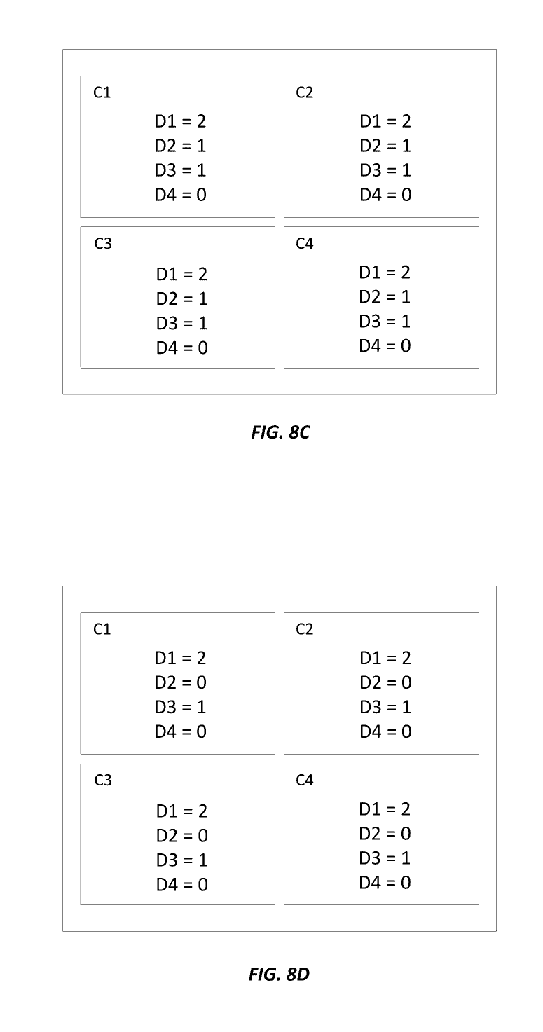

FIG. 7A illustrates a simplified embodiment of a network configuration 700 including four controllers C1, C2, C3 and C4, an access point 706, and clients D1, D2, D3 and D4 associated with the access points, according to embodiments of the present technology. Controllers C1, C2, C3 and C4 are in a controller cluster 714. Clients D1, D2, D3 and D4 each access the cluster 714 via the same access point, access point 706. In this example embodiment, client device D1 may terminate at controller C1, client device D2 may terminate at controller C2, client device D3 may terminate at controller C3, and client device D4 may terminate at controller C4. FIG. 7B illustrates a block diagram of the controller cluster 700 in FIG. 7A with four controllers C1, C2, C3 and C4, according to embodiments of the present technology. Each controller within controller cluster 714 include references to client devices D1, D2, D3 and D4, which are client devices associated with access point 716 as shown in FIG. 7A. As shown in FIG. 7B, each controller has access to a current status of each device in the network (e.g. local area network including each of client devices D1, D2, D3, D4), as represented by the bracketed client devices within each controller in controller cluster 714. Call information regarding potential calls initiated or dropped by each client device may be stored in a storage (e.g. a virtualized storage unit) such as global share memory 614 as described herein with respect to FIG. 6. An example utilizing this shared information including calls being added and dropped from access point 706 is described below with respect to FIGS. 8A-8D.

FIGS. 8A-8D illustrate block diagrams showing a progression of added and dropped calls and related call admission control in an example cluster deployment, according to embodiments of the present technology. In an embodiment, assume that client device D1 may terminate at controller C1, client device D2 may terminate at controller C2, client device D3 may terminate at controller C3, and client device D4 may terminate at controller C4 (as shown, for example, in FIG. 7A). Therefore, controller C1 may have call reservation information (i.e. information related to attempted initiations for new calls, pending calls, or dropped calls) for client D1, controller C2 may have call reservation information for client D2, controller C3 may have call reservation information for client D3, and controller C4 may have call reservation information for client D4. Furthermore, in the embodiment, assume that the call capacity of the access point that clients D1, D2, D3 and D4 are associated with is four (4) calls. As noted herein, the maximum capacity for such an access point may be defined in different ways other than by a number of calls. For example, the maximum capacity for such an access point may be defined by a maximum bandwidth or threshold number of calls of a particular type. In another example, capacity may be determined using Wi-Fi Multimedia (WMM) priority queue utilization. More specifically, an access point may have its own priority queue, including 4 different types: (1) Voice Priority Queue; (2) Video Priority Queue; (3) Best Effort Priority Queue; and (4) Background Priority Queue. These queues may be used as a resource based on the availability of the resource (e.g. available queue size). In another example, capacity may be determined using channel utilization. Channel utilization is a reflection of the extent to which a channel is used at any given point in time. For example, call admission control logic may be used to disallow all calls after a certain percentage of channel utilization has reached a certain threshold (e.g. 80% utilization).

When a call is requested by a client device, the device's corresponding controller may retrieve data or information related to the capacity of the access point. For example, if controller C1 receives a request from client D1 to initiate a call, controller C1 may retrieve data from storage related to how many calls are currently initiated on the access device, the maximum capacity, and any other information related to determining whether the access point has additional capacity to accept another call (i.e. the call requested from D1). C1 may use the retrieved information to compare the number of current pending calls to the maximum capacity of the access device. If the capacity is higher than the number of current pending calls, then then C1 may proceed with initiating the call as requested by D1. If, on the other hand, the capacity is equal to or lower than the number of current pending calls, then C1 may not initiate the call as requested and terminate the request to add a call by D1. As noted, the capacity information may be in forms other than a number of calls pending or allowed; instead, the capacity information may be in the form of available bandwidth (e.g. in MB or GB). The example of using a number of calls is for explanatory purposes only.

As noted, a controller may “retrieve” data related to the access point's current capacity and/or maximum allowed capacity. However, the controller may obtain such information in other ways. For example, the controller may transmit a request for the information to be sent to the controller.

If client D1 attempts to initiate a call when there are no other calls pending or active via the access point, C1 will update the listing of calls in storage (e.g. via a virtualized storage medium, such as global share memory 614 shown in FIG. 6) by changing the listing from zero (0) to one (1) as shown in FIG. 8A. Simultaneously with, or within a short amount of time of, C1 updating the shared storage medium, controllers C2, C3, and C4 have access to the update, as also shown in FIG. 8A. The global share memory 614 may also update the amount of bandwidth reserved for the call and may include that bandwidth in the total bandwidth being used or reserved on the access point in order to determine an updated available bandwidth capacity for the access point.

If, after client D1 initiates a call, D2 and D3 attempt to initiate calls, C2 and C3 will then update the listing of calls in storage, respectively. More specifically, whichever of controller C2 and C3 initiates their call request first would update the listing from one (1) to two (2) and, and the other controller would then update the listing from two (2) to three (3). The result of those two updates are shown in FIG. 8B. More specifically, each of C1, C2, C3, and C4 list D1, D2, and D3 as having one initiated call via the access point. As noted, after the listing of calls is updated in storage by any controller, the other controllers in the cluster may access the updated information via their own versions of the virtual storage device.

If, after clients D1, D2 and D3 initiate calls, D1 attempts to initiate a second call, C1 will then update the listing of calls in storage. More specifically, C4 would update the listing from three (3) to four (4). The result of this update is shown in FIG. 8C. More specifically, each of C1, C2, C3, and C4 list C1 as having two initiated calls and each of C1, C2, C3, and C4 list D2, and D3 as having one initiated call via the access point. As noted, after the listing of calls is updated in storage by any controller, the other controllers in the cluster may access the updated information via their own versions of the virtual storage device.

Since, as noted, the maximum number of calls allowed (i.e. maximum threshold) in this embodiment is four calls, the second call initiated by D1 would cause the maximum to be reached. When the access point's capacity has been reached, the controller initiating the call that causes the maximum to be reached may, as usual, update the storage device with the updated capacity information, which allows the other controllers in the cluster to access the updated capacity information. Alternatively, the controller may actively transmit a notification to the other controllers in the cluster to indicate to the other controllers that the maximum capacity of the access point has been reached.

If, after clients D1, D2, and D3 have initiated calls and the maximum number of calls has been reached, a call is dropped (e.g. ended by the client, or otherwise terminated due to, for example, call error), then the controller may update the stored list of calls similarly to updating the list for new initiated calls. For example, as shown in FIG. 8D, if D2 dropped a call, then C2 may update the list to indicate that D2 has zero (0) active calls pending instead of one (1) active calls pending. As noted, after the listing of calls is updated in storage by any controller, the other controllers in the cluster may access the updated information via their own versions of the virtual storage device.

As noted, in another embodiment, capacity may be measured or determined in ways other than a number of calls. For example, capacity may be measured based on an amount of bandwidth available through an access point. If, for example, the maximum capacity allowed in terms of bandwidth is 10 Gbit/s (i.e. maximum threshold), the second call initiated by D1 may cause the maximum to be reached. To determine this, the total amount of bandwidth (e.g. in Gbit/s or another metric) including the amount needed by the new call may be compared to the maximum threshold (e.g. 10 Gbit/s in the above example). When the access point's capacity has been reached, the controller initiating the call that causes the maximum to be reached may, as usual, update the storage device with the updated capacity information, which allows the other controllers in the cluster to access the updated capacity information. Alternatively, the controller may actively transmit a notification to the other controllers in the cluster to indicate to the other controllers that the maximum capacity of the access point has been reached.

If, after clients D1, D2, and D3 have initiated calls and the maximum bandwidth has been reached, a call is dropped (e.g. ended by the client, or otherwise terminated due to, for example, call error), then the controller may update the stored list of calls similarly to updating the list for new initiated calls. For example, as shown in FIG. 8D, if D2 dropped a call, then C2 may update the list to indicate that D2 has zero (0) active calls (using 0 Gbit/s of bandwidth) pending instead of one (1) active calls pending (using some number of Gbit/s of bandwidth more than 0). As noted, after the listing of calls is updated in storage by any controller, the other controllers in the cluster may access the updated information via their own versions of the virtual storage device.

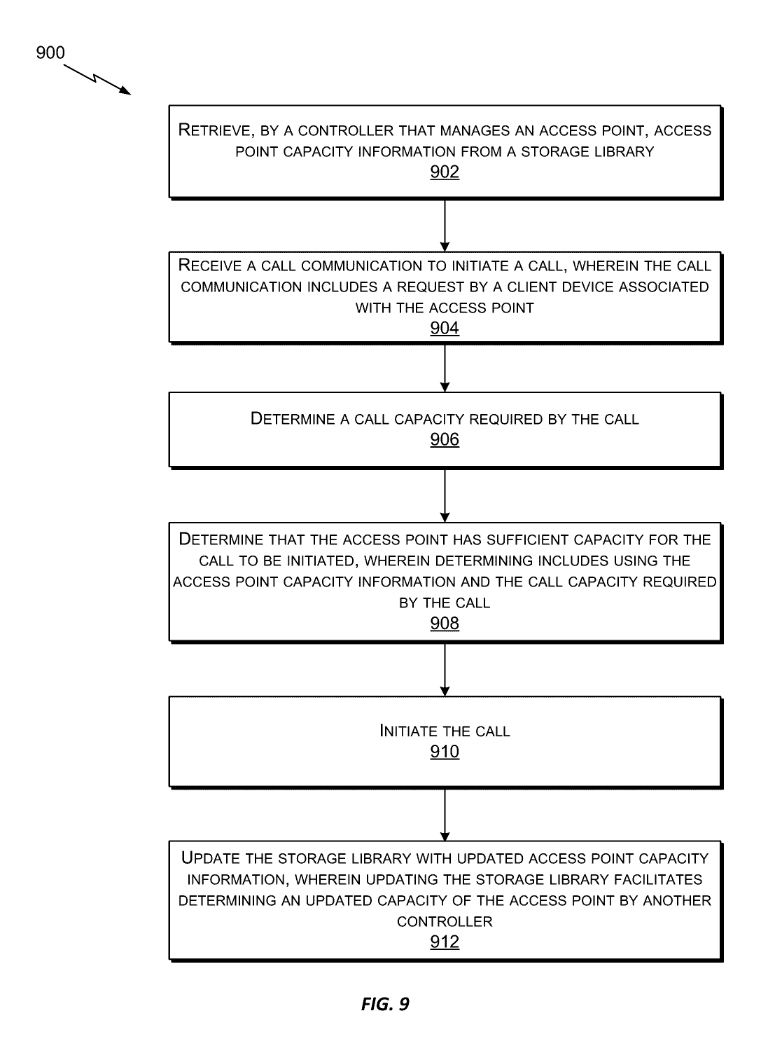

FIG. 9 is a flow chart 900 showing an example process for call admission control for a cluster of controllers, according to embodiments of the present technology. In step 902, a controller managing an access point may retrieve access point capacity information from a storage library. In step 904, the controller may receive a call communication to initiate a call, wherein the call communication includes a request by a client device associated with the access point. In step 906, the access point may determine a call capacity required by the call. In step 908, the controller may determine that the access point has sufficient capacity for the call to be initiated, wherein determining includes using the access point capacity information and the call capacity required by the call. In step 910, the controller may initiate the call. In step 912, the controller may update the storage library with updated access point capacity information, wherein updating the storage library facilitates determining an updated capacity of the access point by another controller.

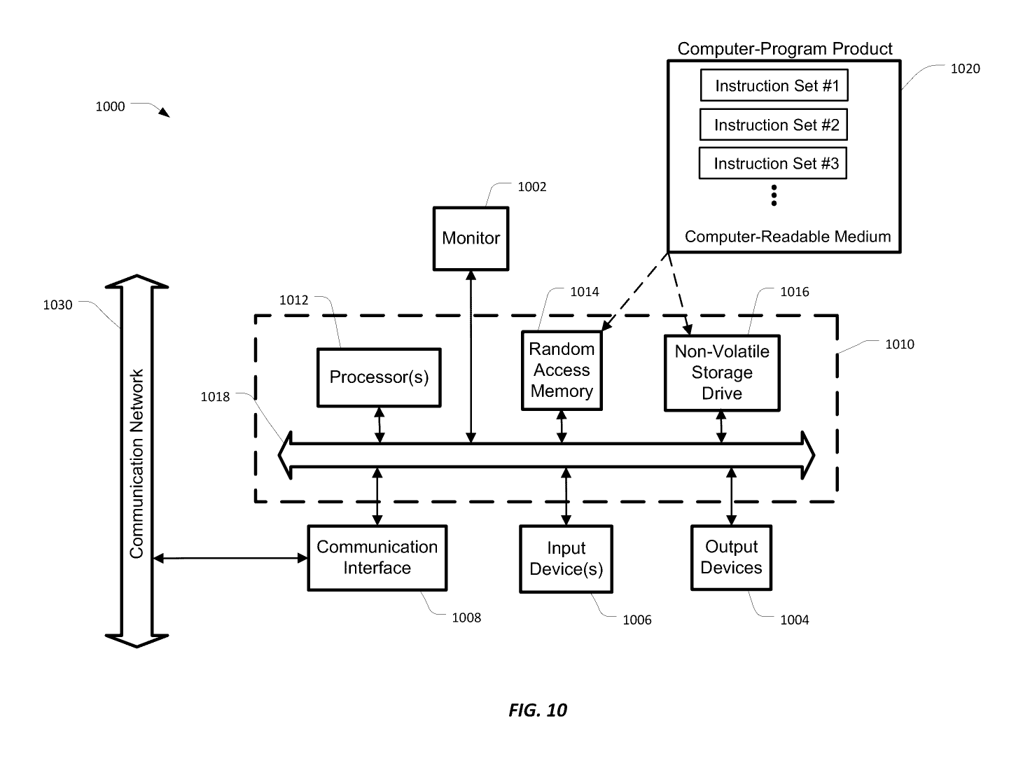

FIG. 10 illustrates an embodiment of a network device 1000. The above methods may be implemented by computer-program products that direct a network device to perform the actions of the above-described methods and components. Each such computer-program product may comprise sets of instructions (code or program code) embodied on a computer-readable medium that directs the processor of a computer system to perform corresponding actions. The instructions may be configured to run in sequential order, or in parallel (such as under different processing threads), or in a combination thereof.

The network device 1000 comprises a processing system 1010, an optional monitor 1002 coupled to the processing system 1010, one or more optional user output devices 1004 coupled to the processing system 1010, one or more optional user input devices 1006 (e.g., keyboard, mouse, track ball, touch screen) coupled to the processing system 1010, an optional communications interface 1008 coupled to the processing system 1010, a computer-program product 1020 stored in a tangible computer-readable memory in the processing system 1010. The computer-program product 1020 directs the network device 1000 to perform the above-described methods. The processing system 1010 may include one or more processors 1012 that communicate with a number of peripheral devices via a bus subsystem 1018. These peripheral devices may include the user output device(s) 1004, user input device(s) 1006, communications interface 1008, and a storage subsystem, such as a random access memory (RAM) 1014 and/or a non-volatile storage drive 1016 (e.g., disk drive, optical drive, solid state drive), which are forms of tangible computer-readable memory.

The computer-program product 1020 may be stored in the non-volatile storage drive 1016 and/or another computer-readable medium accessible to the processing system 1010 and loaded into the memory 1014. Each processor 1012 may comprise a microprocessor, such as a microprocessor from Intel® or Advanced Micro Devices, Inc.®, or the like. To support the computer-program product 1020, the processing system 1010 runs an operating system that handles the communications of the computer-program product 1020 with the above-noted components, as well as the communications between the above-noted components in support of the computer-program product 1020. Exemplary operating systems include ArubaOS from Aruba Networks, Windows® or the like from Microsoft Corporation, Solaris® from Sun Microsystems, LINUX, UNIX, and the like, and/or device- or system-specific operating systems and the like.

The user input devices 1006 may include a keyboard, a keypad, a mouse, a scanner, a digital drawing pad, a touch screen incorporated into the display, audio input devices such as voice recognition systems, microphones, and other types of input devices. In various embodiments, the user input devices 1006 are typically embodied as a computer mouse, a trackball, a track pad, a joystick, wireless remote, a drawing tablet, or a voice command system. The user input devices 1006 typically allow a user to select objects, icons, text and the like that appear on the monitor 1002 via a command such as a click of a button or the like. The user output devices 1004 include devices and mechanisms to output information from the processing system 1010. These may include a display (e.g., a monitor 1002), printers, non-visual displays such as audio output devices, etc.

The communications interface 1008 provides an interface to communication networks 1030 and devices and may serve as an interface to receive data from and transmit data to other systems, WANs and/or the Internet. Embodiments of the communications interface 1008 may be an Ethernet card, a modem, a cable modem, a router, a switch, an embedded multimedia adapter (EMTA), a synchronous or asynchronous digital subscriber line (DSL) unit, a FireWire® interface, a USB® interface, a wireless network adapter, and the like. For example, the communications interface 1008 may be coupled to a computer network, to a FireWire® bus, or the like. In other embodiments, the communications interface 1008 may be physically integrated on a board of the processing system 1010, and/or may be a software program, or the like.

The RAM 1014 and non-volatile storage drive 1016 are examples of tangible computer-readable media configured to store data such as computer-program product embodiments of the systems and methods described herein, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. The RAM 1014 and non-volatile storage drive 1016 may be configured to store the basic programming and data constructs that provide the functionality of various embodiments of the systems and methods described above.

Software instruction sets that provide the functionality of the described methods may be stored in the RAM 1014 and/or non-volatile storage drive 1016. These instruction sets or code may be executed by the processor(s) 1012. The RAM 1014 and/or non-volatile storage drive 1016 may also provide a repository to store data and data structures used in accordance with the disclosed systems and methods. The RAM 1014 and non-volatile storage drive 1016 may include a number of memories including a main random access memory (RAM) to store instructions and data during program execution and a read-only memory (ROM) in which fixed instructions are stored. The RAM 1014 and non-volatile storage drive 1016 may include a file storage subsystem providing persistent (non-volatile) storage of program and/or data files. The RAM 1014 and non-volatile storage drive 1016 may also include removable storage systems, such as removable flash memory.

The bus subsystem 1018 provides a mechanism to allow the various components and subsystems of the computer 1010 to communicate with each other as intended. Although the bus subsystem 1018 is shown schematically as a single bus, alternative embodiments of the bus subsystem 1018 may implement multiple busses or communication paths within the computer 1010.

The preceding description provides example embodiments only, and is not intended to limit the scope, applicability, or configuration of the disclosure. Rather, the preceding description of the example embodiments will provide those skilled in the art with an enabling description for implementing an example embodiment. It should be understood that various changes may be made in the function and arrangement of elements without departing from the spirit and scope of the systems and methods as set forth in the appended claims.

Specific details are given in the preceding description to provide a thorough understanding of the embodiments. It will be understood, however, by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments. The figures and description are not intended to be restrictive.

It is also noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. A processor(s) may perform the necessary tasks.

Systems depicted in some of the figures may be provided in various configurations. In some embodiments, the systems may be configured as a distributed system where one or more components of the system are distributed across one or more networks in a cloud computing system.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc., may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that include or carry instruction(s) and/or data.

Substantial variations may be made in accordance with specific requirements. For example, customized hardware might also be used, and/or particular elements might be implemented in hardware, software (including portable software, such as applets, etc.), or both. Further, connection to other access or computing devices such as network input/output devices may be employed.

In the foregoing specification, aspects of the various systems and methods are described with reference to specific embodiments thereof, but those skilled in the art will recognize that the disclosed systems and methods are not limited thereto. Various features and aspects of the above-described systems and methods may be used individually or jointly. Further, embodiments can be utilized in any number of environments and applications beyond those described herein without departing from the broader spirit and scope of the specification. The specification and drawings are, accordingly, to be regarded as illustrative rather than restrictive.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Where components are described as being configured to perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

While illustrative embodiments of the application have been described in detail herein, it is to be understood that the inventive concepts may be otherwise variously embodied and employed, and that the appended claims are intended to be construed to include such variations, except as limited by the prior art.

What is claimed is:

1. A computer-implemented method, comprising
retrieving, by a controller that manages an access point, access point capacity information from a storage library;
receiving a call communication to initiate a call, wherein the call communication includes a request by a client device associated with the access point;
determining a call capacity required by the call;
determining that the access point has sufficient capacity for the call to be initiated, wherein determining includes using the access point capacity information and the call capacity required by the call;
initiating the call; and
updating the storage library with updated access point capacity information, wherein updating the storage library facilitates determining an updated capacity of the access point by another controller.

2. The method of claim 1, wherein updated access point capacity information is determined using the access point capacity information and initiation of the call.

3. The method of claim 1, wherein determining a call capacity required by the call further includes:
transmitting a communication including a request for the call capacity required by the call; and
receiving a response to the communication including the call capacity required by the call.

4. The method of claim 1, further comprising:
determining a type of call associated with the call; and
determining that the access point has enough capacity for the call to be initiated using the type of call, the access point capacity information, and the call capacity required by the call.

5. The method of claim 1, wherein the another controller manages the access point.

6. The method of claim 1, wherein the access point capacity information includes a number of active calls on the access point, and wherein determining that the access point has sufficient capacity for the call to be initiated includes comparing the number of active calls on the access point to a threshold number of calls.

7. The method of claim 1, wherein the access point capacity information includes an amount of bandwidth available on the access point, and wherein determining that the access point has sufficient capacity for the call to be initiated includes comparing the call capacity required by the call to a threshold amount or percentage of bandwidth.

8. The method of claim 1, wherein access point capacity information includes a number of calls or an amount of bandwidth available on the access point.

9. A network device, comprising:
one or more processors;
a non-transitory computer-readable medium containing instructions that, when executed by the one or more processors, cause the one or more processors to perform operations including:
retrieving, by a controller that manages an access point, access point capacity information from a storage library;
receiving a call communication to initiate a call, wherein the call communication includes a request by a client device associated with the access point;
determining a call capacity required by the call;
determining that the access point has sufficient capacity for the call to be initiated, wherein determining includes using the access point capacity information and the call capacity required by the call;
initiating the call; and
updating the storage library with updated access point capacity information, wherein updating the storage library facilitates determining an updated capacity of the access point by another controller.

10. The network device of claim 9, wherein updated access point capacity information is determined using the access point capacity information and initiation of the call.

11. The network device of claim 9, wherein determining a call capacity required by the call further includes:
transmitting a communication including a request for the call capacity required by the call; and
receiving a response to the communication including the call capacity required by the call.

12. The network device of claim 9, further comprising instructions that, when executed by the one or more processors, cause the one or more processors to perform operations including:
determining a type of call associated with the call; and
determining that the access point has enough capacity for the call to be initiated using the type of call, the access point capacity information, and the call capacity required by the call.

13. The network device of claim 9, wherein the another controller manages the access point.

14. The network device of claim 9, wherein the access point capacity information includes a number of active calls on the access point, and wherein determining that the access point has sufficient capacity for the call to be initiated includes comparing the number of active calls on the access point to a threshold number of calls.

15. The network device of claim 9, wherein the access point capacity information includes an amount of bandwidth available on the access point, and wherein determining that the access point has sufficient capacity for the call to be initiated includes comparing the call capacity required by the call to a threshold amount or percentage of bandwidth.

16. The network device of claim 9, wherein access point capacity information includes a number of calls or an amount of bandwidth available on the access point.

17. A computer-program product tangibly embodied in a non-transitory machine-readable storage medium of a computing device, including instructions that, when executed by one or more processors, cause the one or more processors to:
retrieve, by a controller that manages an access point, access point capacity information from a storage library;
receive a call communication to initiate a call, wherein the call communication includes a request by a client device associated with the access point;
determine a call capacity required by the call;
determine that the access point has sufficient capacity for the call to be initiated, wherein determining includes using the access point capacity information and the call capacity required by the call;
initiate the call; and
update the storage library with updated access point capacity information, wherein updating the storage library facilitates determining an updated capacity of the access point by another controller.

18. The computer-program product of claim 17, wherein updated access point capacity information is determined using the access point capacity information and initiation of the call.

19. The computer-program product of claim 17, wherein determining a call capacity required by the call includes:
transmitting a communication including a request for the call capacity required by the call; and
receiving a response to the communication including the call capacity required by the call.

20. The computer-program product of claim 17, further comprising instructions that, when executed by one or more processors, cause the one or more processors to:
determine a type of call associated with the call; and
determine that the access point has enough capacity for the call to be initiated using the type of call, the access point capacity information, and the call capacity required by the call.
